(19) United States
(12) Patent Application Publication
(10) Pub. No.: US 2007/0070218 A1
(43) Pub. Date: Mar. 29, 2007

(54) Storage system for retaining identification data to allow retrieval of media content

(75) Inventors: Joost Meijer, Eindhoven (NL); Johan Gerhard Herman Reuzel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/580,492

(22) PCT Filed: Nov. 19, 2004
(86) PCT No.: PCT/IB04/52486

§ 371 Date: May 23, 2006

(30) Foreign Application Priority Data
Nov. 27, 2003 (EP) 03104417.5

(51) Int. Cl. H04N 5/76

(52) U.S. Cl. 348/231.99

(57) ABSTRACT

The invention relates to a data-storage system (100, 200) comprising a processor means (110, 260) for obtaining identifier data of media content existing in the system, the identifier data being used for identifying the media content, and a memory (120, 265) for retaining the identifier data after the media content is absent from the system, a retrieval means being arranged to allow retrieval of the media content using the identifier data. The system, for example, a video camera retains the identifier data after the media content has been deleted or removed from the system. The identifier data may accumulate in the system independently of the media content, while the media content may still be retrieved.

The invention relates to a data-storage system for obtaining identification data for media content. The invention also relates to a method of storing data and a computer program product.

US2002//0140843 discloses a digital camera for capturing digital images and recording meta-data. The meta-data may be specific to the operational conditions of the recording device during the capture, and attached to the digital images. For example, the meta-data may include information such as a focusing distance, date, time, etc. The meta-data may be used for identifying classifiers, i.e. semantic descriptions associated witli the captured video content. The digital images and the meta-data are transmitted to a data-processing system.

Devices for obtaining media content, for example, the camera as described in US2002//0140843, or a video recorder arranged to receive video signals, may have a temporary storage means or a storage means with limited capabilities. Therefore, the media content has to be transferred to another storage means, overwritten or deleted, and the content may not be found anymore.

It is an object of the invention to provide a system which allows finding the media content which had been present in the system before the media content was removed or deleted.

The object is realized in that the invention provides a data-storage system comprising:

a processor means for obtaining identifier data of media content existing in the system, the identifier data being used for identifying the media content, and

a memory for retaining the identifier data after the media content is absent from the system,

a retrieval means being arranged to allow retrieval of the media content using the identifier data

For example, the data-storage system may obtain the media content and identifier data in a digital stream. Alternatively, the system may obtain only media data, without the identifier data, and the identifier data may be generated independently, e.g. locally in the system. The identifier data is data which allows identification of the media content when the media content is not in the system anymore, e.g. when the content is removed, and retrieval of the media content using the identifier data The media content may be obtained in different ways. For example, the system may comprise one or more content-recording devices, e.g. a video camera. Alternatively, the system may comprise a TV tuner, wireless communication means, an Internet modem, etc.

The system retains the identifier data after the media content has been removed from the system, overwritten or deleted. The identifier data may accumulate in the system independently of the media content. It is an advantage of the present invention that the media content does not have to be stored in the system but may still be retrieved by using the identifier data. To store the identifier data, a storage capacity may be required in the system, which capacity is significantly smaller than for storing the media content. For example, the system may comprise a mobile device with a relatively small storage capacity, but the user may use the mobile device for obtaining the identifier data that allows retrieval of the media content when the media content is stored remotely from the system.

The identifier data may be attached to, for example, meta-data describing the media content. The meta-data may enable a user of the system to store with the identifier data any information about the media content, for example, a text description, a diary, etc. In another example, the identifier data may be the descriptive data, i.e. the meta-data.

The identifier data may be obtained by analyzing the media content. For example, video information such as still images, video frames in a video stream, etc. may have unique characteristics, e.g. a size, type, format of the image, a mean absolute difference (MAD) value of the video stream according to the MPEG (Moving Picture Experts Group) standard. The MAD value may be extracted when the video data are MPEG-encrypted. In another example, the identifier data may simply be a unique combination of symbols assigned to the media content by the system, or a hash value.

The identifier data may comprise information which is sufficient to retrieve the media content stored elsewhere. For example, the identifier data may comprise storage identifier data indicating a storage device external to the system, and location data indicating the location of the media content in the external storage device. For instance, the storage identifier data may identify a personal computer (PC) in a home network of a user, and the location data may comprise information about a folder and/or a computer file name where the media content is stored on the PC.

The processor means may be arranged to function as the retrieval means. Alternatively, the retrieval means may be implemented as a separate unit of the system, e.g. as a retrieval processor means suitably arranged to function as the retrieval means.

The object of the invention is also realized in that the method of storing data according to the present invention comprises the steps of:

obtaining identifier data of media content existing in a data-storage system, the identifier data being used for identifying the media content,

retaining the identifier data after the media content is absent from the system, and

allowing retrieval of the media content by using the identifier data.

The method describes an operation of the system according to the present invention.

These and other aspects of the invention will be further explained and described with reference to the following drawings:

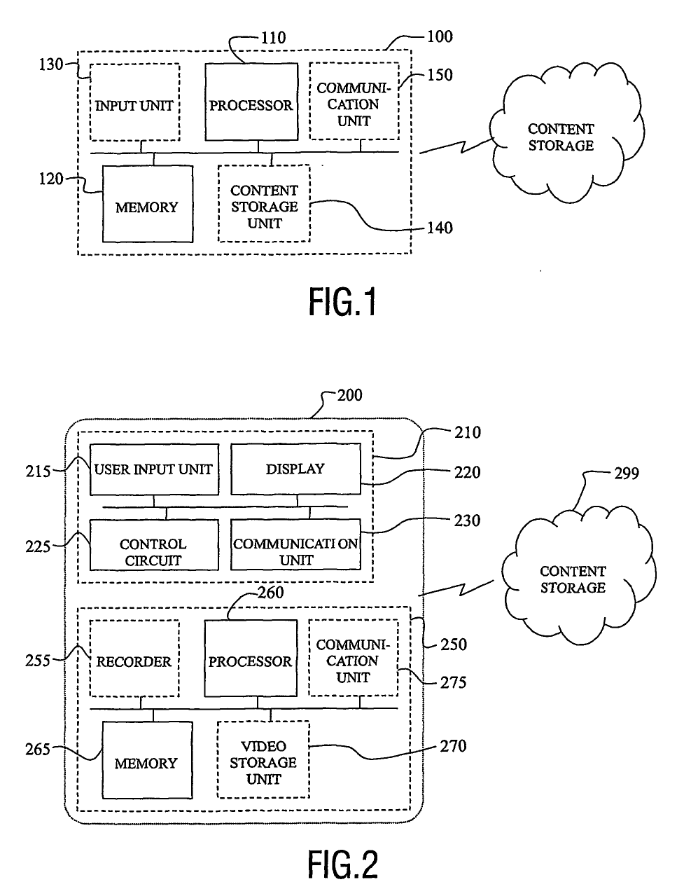

FIG. 1 is a functional block diagram of an embodiment of a system according to the present invention;

FIG. 2 is a functional block diagram of another embodiment of a system according to the present invention, where the system comprises a video recording device and a personal digital assistant device (PDA);

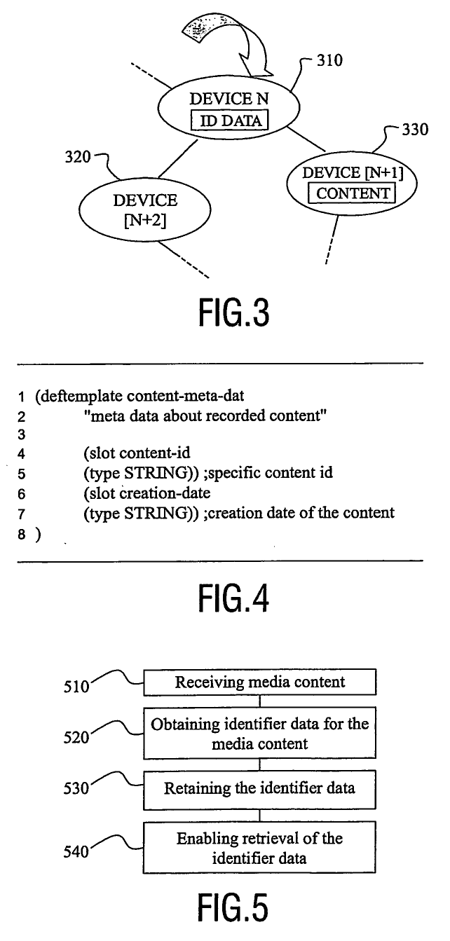

FIG. 3 is a block diagram of a system according to the present invention, and a plurality of devices not comprised in the system;

FIG. 4 is an example of expressing the identifier data using a formal language; and

FIG. 5 is an embodiment of the method of the present invention.

FIG. 1 shows an embodiment of the system according to the present invention. The system 100 comprises a processor means 110 (further referred to as “processor”) and a memory 120. The system may optionally comprise an input unit 130, a content storage unit 140 and a communication unit 150.

The processor 110 may be coupled to the input unit 130 for obtaining media content by recording the media content, receiving the media content, etc. The input unit may comprise a photo camera for taking pictures, a video camera for shooting a film, a personal video recorder (PVR), a TV tuner, a computer equipped with a network card for connecting the computer to a data network, or any other device suitable for obtaining the media content For example, the input unit may receive video data in known manner from a video content broadcaster, e.g. using digital video broadcasting (DVB), video-on-demand systems, Internet radio systems, etc.

The media content may comprise at least one or any combination of visual information, audio information, text, or the like. The expression “audio data”, or “audio content”, is hereinafter used as data pertaining to audio comprising audible tones, silence, speech, music, tranquility, external noise or the like. The expression “video data”, or “video content”, is used as data which are visible such as a motion picture, a static image, characters, etc.

The input unit 130 may be arranged to read out the media content stored on different data carriers such as audio tapes, video tapes, optical storage discs, e.g. a CD-ROM (Compact Disc Read Only Memory) or a DVD (Digital Versatile Disc), floppy and hard drive disks, etc. in any format, e.g. MPEG (Moving Picture Experts Group), MDI (Musical Instrument Digital Interface), Shockwave, QuickTime, WAV (Waveform Audio), etc.

The content storage unit 140 may be arranged to temporarily store the obtained media content of different types and formats in known manner. For example, the content storage unit may comprise a computer hard drive, a versatile flash memory card, e.g. a “Memory Stick” device, etc.

A user of the system may find the media content if it is stored in the system. If the media content is deleted or removed from the system, and the system does not store any information about the media content which is absent from the system, the system does not allow finding the media content anymore. The present invention aims at enabling the system to retrieve or to allow retrieval of the media content. To this end, the system comprises the memory 120 for retaining the identifier data after the media content is absent from the system. The identifier data may be any data which allows said retrieval.

For example, the identifier data may be a record in the memory 120 indicating a name of a particular media content item. The name may be attached to the content item and stored with the content item in another device, not comprised in the system. Of course, this is merely a simple example, and the identifier data may be more complex.

The processor 110 may be arranged to obtain the identifier data in different manners. For example, the identifier data may be obtained together with the media content Audio or video fragments, e.g. MPEG data frames, of the media content with meta-data, comprising the identifier data, attached to or embedded in the fragments (for instance, a MPEG-data file with a header comprising information about the media content) may be obtained by the input unit. For instance, in Digital Video Broadcast (DVB) systems, a number of digital streams are transmitted carrying video data, audio data and additional information, which may comprise the identifier data. The processor may be arranged to extract the identifier data from the received media content with the meta-data. A provider of the media content may provide the media content item with a predetermined, unique serial code.

In another example, the processor may be arranged to generate identifier data for the media content item. The processor may analyze the media content and generate the identifier data on the basis of the content of the item. Since every item has its unique content, the identifier may also be characteristic of the particular item only. For instance, a movie usually has a unique year of its production or release, or a specific title. This information may be used to generate a short code for the particular content item in accordance with certain algorithms. The analysis of the media content may also comprise, for example, use of video or audio characteristics of the media content.

In a further example, the processor may be arranged to interrogate a storage device (not shown) external to the system, i.e. the device which is not comprised in the system, so as to provide the identifier data for the particular media content item. The external device may be arranged to obtain the identifier data in any manner which results in the identifier suitably recognizing the content item unambiguously. For instance, the identifier data may comprise a storage identifier, e.g. a link, address, or the like, of the external device and the identifier generated by this device, e.g. location data indicating the location of the content item in the device. As an example, such location data may be a name of the computer/hard-drive disk, a name of a folder and/or a name of a file comprising the media content item, e.g. “PC name:\disc name\folder name\file name” (in this case, the file name might have been generated by the computer). The external device may generate and transmit the identifier data after the system has transmitted the media content, e.g. by means of the communication unit 150, to the external device, and the content is not available in the system anymore.

In the example with the external storage device, the processor may control the communication unit to communicate the external storage device. After the media content has been offloaded to the external device and the device has generated the identifier data, the external device may transmit the identifier data to the system. For instance, the processor may receive, from the external device, the identifier data in a return receipt for the media content, acknowledging the reception and storage of the media content in the external device.

In a further example, the external device may not be arranged to generate or store the identifier data after the reception of the media content from the system. Before the media content is deleted or removed from the system, the processor may execute a software program to generate identifier data for the content item and store the generated identifier data in the memory. The identifier data may be retained in the memory after the content is not in the system. The software may generate the same identifier data independently of where it is run, and independently of where the content item is stored. To allow retrieval of the media content item, the processor may transmit the software program to the external storage device. The external device may be arranged to execute the software to generate the identifier data for the media content items stored in the external device. The identifier data for one of the items stored in the external device will match with the identifier data-retained in the memory of the system for the particular item. The processor may be arranged to detect such a match between the identifier data stored in the memory of the system and the identifier data generated in the external device. Upon detection of the match, the media content corresponding to the identifier data may be retrieved from the external device to the system or any other equipment not comprised in the system, e.g. to a further external device.

The processor may be arranged to enable the user to input the identifier data by using the input unit. The input unit may generally comprise known input devices such as a remote control unit, a keyboard, a pointing device like a mouse, etc. For instance, the user may input the identifier data for the particular media content item and a command for the processor to transfer the item to an external storage device. The identifier data may comprise the storage identification information for identifying the external storage device to which the content item is to be transferred. Thus, the user may specify the external storage device using the input unit.

The system 100 shown in FIG. 1 may be a video camera for recording the media content. The camera may be arranged to accumulate information about the content recorded with the camera. The information, e.g. a time, date, place of recording (e.g. a geographical location where the content has been recorded), an identity of a person who operated the camera, etc. may be generated automatically. This information may be used to generate the identifier data, for example, by retaining the time and date of the video recording in the memory.

In another embodiment, the system 100 may be a personal video recorder. The video recorder may be arranged to receive the media content with the identifier data embedded therein, or to receive the media content item and generate the identifier data. The video recorder may generate the identifier data, for example, by applying a speech recognition technique to the audio data in the MPEG stream, utilizing the recognized speech text to identify in a multimedia content database. The database may comprise different information about the content items, such as a title, year of production, author, summary, duration, etc. Alternatively, if the media content item is provided with EPG (Electronic Programme Guide) data, the identifier data may also be generated on the basis of information about the content item available in the EPG data. For example, it is well known that the EPG data may comprise information about actors in a movie, a TV channel broadcasting the respective content item on a certain day and certain hours, etc. The processor 110 of the video recorder may be arranged to obtain said information about the content item and associate it with a certain code which is also the identifier of the content item. Both the information and the code may be retained in the memory. For instance, the code may simply be a number given to the content item and stored in the memory, or a date/time when the identifier data is recorded in the memory.

FIG. 2 shows an embodiment of the system 200 of the present invention. The system comprises the personal digital assistant device (PDA) 210 and the video camera 250. The system may be arranged to communicate with an external content storage device 299, e.g. a home server in a user's home network.

The devices of the system may be mobile and may need a wireless infrastructure for communicating with each other, as well as with the remote external storage device. The devices requiring a wireless network bandwidth for transferring large amounts of information may be connected by using existing technologies, such as Bluetooth, 802.11[a-g], etc.

The camera may comprise a recording unit 255 for taking digital pictures, a processor 260 for generating the identifier data, a memory 265 for retaining the pictures, a video storage unit 270 for temporarily storing the pictures until the pictures are offloaded from the camera, and a communication unit 275 for offloading the pictures and communicating with the PDA.

The PDA may comprise a user input unit 215 for enabling a user to provide his input to the PDA, a display 220 for displaying information to the user, a control circuit 225 for enabling the PDA to function as will be further explained, and a communication unit 230 for communicating with the camera and any other device (including the home server, etc.) to ensure allowing the retrieval of the media content. The communication unit 230 of the PDA and the communication unit 275 of the camera may be arranged to communicate, using, for example, the wireless network.

The system shown in FIG. 2 may be used in accordance with a scenario described below merely as an example. The user uses his digital camera to take pictures during his holiday. The camera attaches a time/date stamp to the pictures taken, e.g. by means of the processor 260. When the user returns home, he transfers the images from his camera to the home server for storing them. Thus, the home server stores the images and the time/date stamp. The camera may generate the identification data comprising the time/date stamp and an indication that the images are stored in the home server, and retain the identification data in the memory 265. The user also keeps his diary on the PDA while being on holiday. In his diary, the user describes certain pictures which he takes with his camera The time and the date when the picture is taken are also stored in the diary at the PDA, as well as in the camera, so that corresponding pictures may be identified in the PDA and the camera To store the diary and the time/date for the images, the PDA may comprise a memory means (not shown).

Alternatively, the PDA may store the time/dates and corresponding descriptions of the pictures. The camera may store the pictures, the time/dates and the identifier data (not being the time/date), e.g. the hash value. After the pictures have been deleted in the camera, the home server may store the pictures and the identifier data, not including the time/date.

After the user returns from his holiday, he likes to show some photos to his friends. The user visits his friends and takes the PDA with him. The user browses his diary using the PDA and presses a button to show the picture corresponding to a particular entry in the diary. The PDA communicates with the camera, which the user left at home, and sends a request to the camera so as to find the particular image which was recorded by the camera at the particular time and date. In other words, the PDA requests help with the task of finding the image, and the camera is able to perform the task. The camera is able to provide the requested information to the PDA because the camera retained the identification data and the identification data indicates that the images are stored in the home server of the user. Thus, the request of the PDA may be translated into a specific pointer to the home server for storing the content.

The PDA may be arranged to determine a display device, generally a presentation device, which is available at the moment for displaying the user content at the place of the user's friends. This may be realized through advertising techniques. The PDA may send a request for the display device in a local home network of the friends' place. For example, a television set may be connected in the local network and display the images. The display device in the friends' home network sends a reply message to the PDA with a specification of video formats of content that the display device may display. Of course, the PDA may be arranged to communicate with the devices in the local home network in known manner. Thus, the PDA tries to display the required images as locally to the user as possible, provided that the display device in the friends' local network is able to obtain the content from the user's home server.

Therefore, the PDA obtains the information about where the required images are stored, where the required images may be displayed, and how to find the images in the home server (on the basis of the time/date stamp attached to the images). This information enables the PDA to initiate the retrieval of the required images from the home server to the display device. The PDA may be arranged to find a service which will be able to establish a content stream, i.e. the content transfer. The home server may be arranged to provide such a service to the PDA, and the PDA sends to the home server the time/date stamp of the images to be transferred to the television set. For example, the home server, a content source device, may be connected with the television set, a sink for the content stream. The remote home server further communicates with the television set in the local network to display the images in known manner. The home server provides the content to the television set. The television set, PDA and home server may interact in accordance with the UPnP (Universal Plug and Play) standard.

In fact, the PDA stores inventory of information about pictures taken by the camera, and the inventory may be used for remote access and retrieval of the pictures. The camera may also generate and store information about the user's identity and a location at which the respective picture is taken, e.g. by using the known GPS (Global Positioning Systems) techniques. The PDA is an object which the user may bring along to his friends when the pictures should be displayed at his friends' place. The connection between the home server and the display device is set up when the pictures should be displayed.

FIG. 3 shows a diagram illustrating the present invention. The system comprises a device 310, e.g. the video recorder arranged to store the identifier data. A plurality of remote storage devices, e.g. remote video recorders 320 and 330 may be arranged to establish a connection with the system 310 via a point-to-point (P2P) network in known manner.

The system 310 may be arranged to receive the media content, for example, broadcast television programs. The system may retain the identifier data for the received programs, whereas the received programs may be deleted, offloaded or removed from any of the devices 320 and 330. According to the present invention, the system may retrieve the programs which are not available in the system, using the retained identifier data For example, the video recorder 310 may retrieve the required television program from the remote device 330 storing the program, via the P2P network.

The devices 320 and 330 may be any of various consumer electronics devices such as a television set (TV set) with a cable, satellite or other link, a video cassette recorder (VCR), a home cinema system, a CD player, a remote control device such as an I-Pronto remote control, etc.

The identifier data may be expressed through use of, e.g. Extensible Markup Language (XML) whose standardization is pursued by the World Wide Web Consortium. An example of the identifier data expressed using the CLIPS (C Language Integrated Production System) language is shown in FIG. 4. CLIPS is a productive development and delivery expert system tool which provides a complete environment for the construction of rule and/or object-based expert systems. Other languages may also be used.

FIG. 5 shows an embodiment of the method of the present invention. The embodiment describes the operation of the system according to the present invention. Further modifications of the method may be derived as shown in FIGS. 1, 2 and 3.

The method comprises a step 510 of obtaining media content, for example, using the video camera for recording the video content, the personal video recorder for receiving and/or recording video signals. In the other example, the system may comprise the PDA and the video camera.

At step 520, the identifier data may be obtained in different manners for the media content. For example, the identifier data may be received in a form embedded in the media content stream, the identifier data may be generated, or a user may simply input the identifier data manually. The identifier data may be established while the media content is still in the system, or after the media content has been deleted or removed from the system.

Step 530 comprises the retaining of the identifier data after the media content is absent from the system. For example, the identifier data may be retained in the memory of the system as shown in FIG. 1 or FIG. 2. Alternatively, the identifier data themselves may be retained elsewhere, not in the system, but the system may be arranged, for example, to access the identifier data.

At step 540, the retrieval of the media content is enabled, for example, by using the identifier data to determine the external storage device in which the media content is stored, by transmitting the special software algorithms to the external storage device to identify the media content item stored therein, etc.

Various computer program products may implement the functions of the device and method of the present invention and may be combined in several ways with the hardware or located in different other devices.

Variations and modifications of the described embodiment are possible within the scope of the inventive concept. For example, the system according to the present invention may comprise a portable device for recording the audio data. In one example, the system may be arranged to identify a person whose voice is recorded, e.g. by analyzing the speech of the person and comparing results of the analysis with his audio profile data, in any known manner. The identity of the person may be established in this way. The identity information together with the time/date of the recording may be used as the identifier data for the recorded audio data

Use of the verb ‘comprise’ and its conjugations does not exclude the presence of elements or steps other than those defined in a claim. The invention can be implemented by means of hardware comprising several distinct elements, and by means of a suitably programmed computer. In the system claim enumerating several means, several of these means can be embodied by one and the same item of hardware.

1. A data-storage system (100, 200) comprising:
a processor means (110, 260) for obtaining identifier data of media content existing in the system, the identifier data being used for identifying the media content, and
a memory (120, 265) for retaining the identifier data after the media content is absent from the system,
a retrieval means (110, 260) being arranged to allow retrieval of the media content using the identifier data.

2. The data-storage system of claim 1, wherein the retrieval means is arranged to allow retrieval of the media content, which is absent in the system and stored in a first device (299) external to the system, from the first device to a second device external to the system.

3. The data-storage system of claim 1, wherein the processor means is arranged to allow generating the identifier data by analyzing media content stored in a device (299) external to the system, for retrieval of the media content from said external device.

4. The data-storage system of claim 1, wherein the processor means is arranged to receive the identifier data with the media content, or to generate the identifier data.

5. The data-storage system of claim 1, wherein the processor means is arranged to obtain the identifier data after the media content is absent from the system.

6. The data-storage system of claim 5, wherein the processor means is arranged to receive the identifier data from a device external to the system (299), the external device being arranged to obtain the identifier data (generated/extracted) for the media content.

7. The data-storage system of claim 1, wherein the system further comprises a recorder (255) for recording the media content, and/or a storage means (140, 270) for storing the media content before the media content is absent from the system.

8. The data-storage system of claim 1, wherein
the processor means is arranged to enable a user to input meta-data describing the media content, or
the processor means is arranged to enable a user to input the identifier data.

9. The data-storage system of claim 1, wherein the identifier data comprise:
storage identifier data indicating a storage device (299) external to the system, the device being arranged to store the media content after the media content is absent from the system, and/or
location data indicating the location of the media content in the external storage device.

10. The data-storage system of claim 1, wherein the identifier data relate to meta-data describing the media content, the meta-data comprising information about at least one of:
a time and/or a date when the media content is recorded,
a location where the media content is recorded,
a user identity data.

11. The data-storage system of claim 1, wherein the processor means is arranged to:
select meta-data describing a desired media content,
find the identifier data corresponding to the selected meta-data,
determine a content-storage device (299) in which the desired content is stored,
determine a presentation device for presenting the content,
enable the presentation device to obtain the content from the content-storage device.

12. At least one consumer electronics product being one of a video camera, a computer (PDA), a video recorder, or a remote control device, comprised in the data-storage system as claimed in claim 1.

13. A method of storing data, the method comprising the steps of:
(520) obtaining identifier data of media content existing in a data-storage system, the identifier data being used for identifying the media content,
(530) retaining the identifier data after the media content is absent from the system, and
(540) allowing retrieval of the media content using the identifier data.

14. A computer program product enabling a programmable device, when executing said computer program product, to function as the system as defined in claim 1.
